(19) United States
(12) Patent Application Publication
(10) Pub. No.: US 2006/0079998 A1
(43) Pub. Date: Apr. 13, 2006

(54) Security robot

(75) Inventors: Taizou Yoshikawa, Wako-shi (JP); Masakazu Kawai, Wako-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: HONDA MOTOR CO., LTD.

(21) Appl. No.: 11/167,207

(22) Filed: Jun. 28, 2005

(30) Foreign Application Priority Data
Jun. 30, 2004 (JP) 2004-193756

(51) Int. Cl. G06F 19/00

(52) U.S. Cl. 700/245

(57) ABSTRACT

A security robot that boards a mobile unit to protect the mobile unit from theft is provided. The robot has an internal sensor such as an acceleration sensor installed at the robot and generating an output indicative of condition inside the robot, an external sensor such as CCD cameras installed at the robot and generating an output indicative of condition outside the robot, an abnormality degree discriminator discriminating a degree of abnormality that the mobile unit is experiencing based on information obtained from the outputs of the internal sensor and the external sensor, and an action controller taking preventive action in response to the discriminated degree of abnormality. With this, it becomes possible to discriminate the degree of abnormal situations and act accordingly in response.

### BACKGROUND OF THE INVENTION

1. Field of the Invention

This invention relates to a security robot, particularly to a mobile robot that boards (sits in) a vehicle or other mobile unit to protect the mobile unit from theft.

2. Description of the Related Art

Known security robots include, for example, the one taught by Japanese Laid-Open Patent Application No. 2001-222317. This prior art reference relates to a pet-like robot that is equipped with one or more external sensors including a microphone and/or a CCD camera and can move about freely within a room. The robot gathers information regarding its surroundings that it transmits to an outside security services company together with owner information. When the external recipient discerns a problem with the surroundings from the received information, it notifies the owner.

However, this prior art robot is obviously not capable of boarding a vehicle or other mobile unit. Moreover, it can function only as a sensor and is not capable of discriminating the severity of problems and acting accordingly. Thus the robot system is configured so that actions in response to the information the robot transmits to the outside recipient regarding its surroundings are initiated at a remote location. The system is therefore incapable of responding quickly to abnormal situations with immediate effect.

### SUMMARY OF THE INVENTION

An object of this invention is therefore to overcome these drawbacks by providing a security robot capable of boarding a mobile unit that can discriminate the degree of abnormal situations and act accordingly in response.

In order to achieve the object, a security robot that boards a mobile unit to protect the mobile unit from theft, comprising: an internal sensor installed at the robot and generating an output indicative of condition inside the robot; an external sensor installed at the robot and generating an output indicative of condition outside the robot; an abnormality degree discriminator discriminating a degree of abnormality that the mobile unit is experiencing based on information obtained from the outputs of the internal sensor and the external sensor; and an action controller taking preventive action in response to the discriminated degree of abnormality.

### BRIEF DESCRIPTION OF THE DRAWINGS

The above and other objects and advantages of the invention will be more apparent from the following description and drawings in which:

FIG. 1 is a front view of a security robot according to an embodiment of the invention;

FIG. 2 is side view of the security robot shown in FIG. 1;

FIG. 3 is an explanatory view showing a skeletonized view of the security robot shown in FIG. 1;

FIG. 4 is an explanatory view showing the security robot of FIG. 1 aboard a vehicle (mobile unit);

FIG. 5 is a sectional view showing the internal structure of the head of the security robot of FIG. 1;

FIG. 6 is a block diagram showing the configuration of an electronic control unit (ECU) shown in FIG. 3;

FIG. 7 is a block diagram functionally illustrating the operation of a microcomputer of the electronic control unit (ECU) shown in FIG. 6;

FIG. 8 is an explanatory diagram showing degrees of abnormality and the like discriminated by an abnormality degree discriminator shown in FIG. 7; and

FIG. 9 is a flowchart showing the sequence of operations of the security robot of FIG. 1.

### DETAILED DESCRIPTION OF THE PREFERRED EMBODIMENT

Preferred embodiment of the security robot according to the invention will now be explained with reference to the attached drawings.

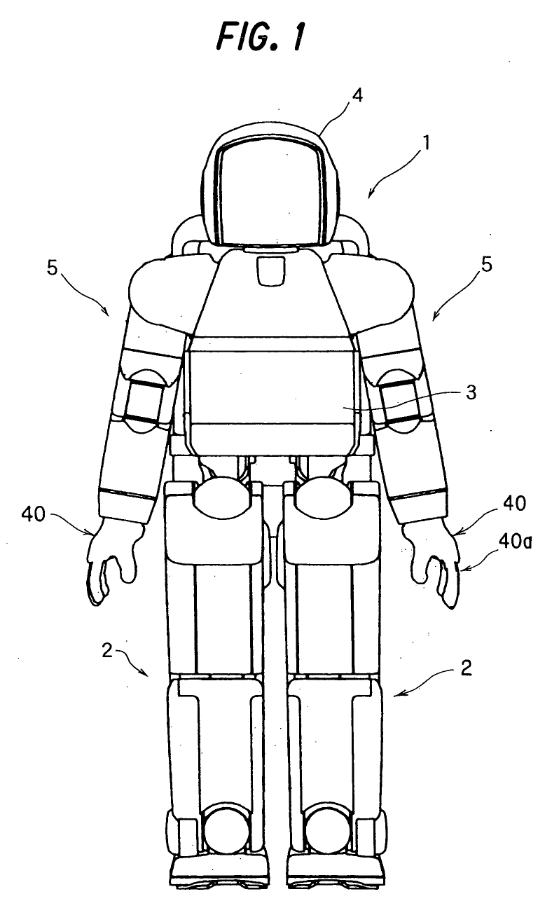

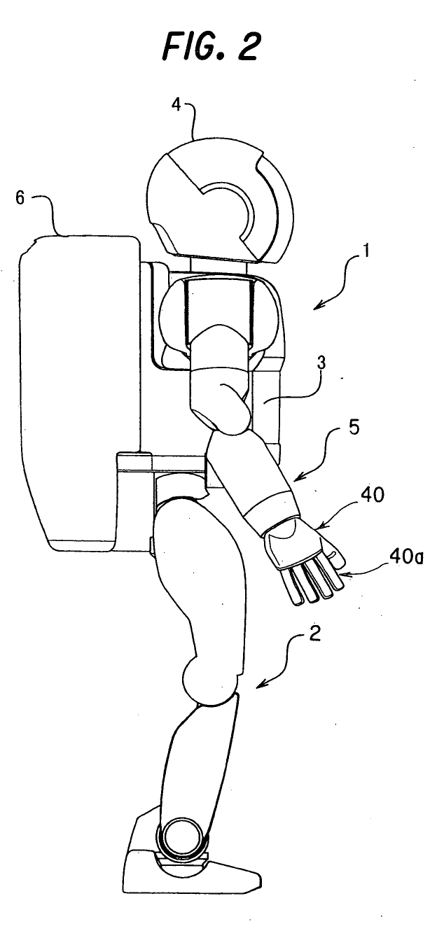

FIG. 1 is a front view of a security robot according to an embodiment of the invention and FIG. 2 is a side view thereof. A humanoid legged mobile robot (mobile robot modeled after the form of the human body) provided with two legs and two arms and capable of bipedal locomotion, is taken as an example of security robots.

As shown in FIG. 1, the robot (now assigned with reference numeral 1) is equipped with a plurality, specifically a pair of leg linkages 2 and a body (upper body) 3 above the leg linkages 2. A head 4 is formed on the upper end of the body 3 and two arm linkages 5 are connected to opposite sides of the body 3. As shown in FIG. 2, a housing unit 6 is mounted on the back of the body 3 for accommodating an electronic control unit (explained later), a battery and the like.

The robot 1 shown in FIGS. 1 and 2 is equipped with covers for protecting its internal structures. A keyless entry system 7 (not shown in FIG. 2) is provided inside the robot 1.

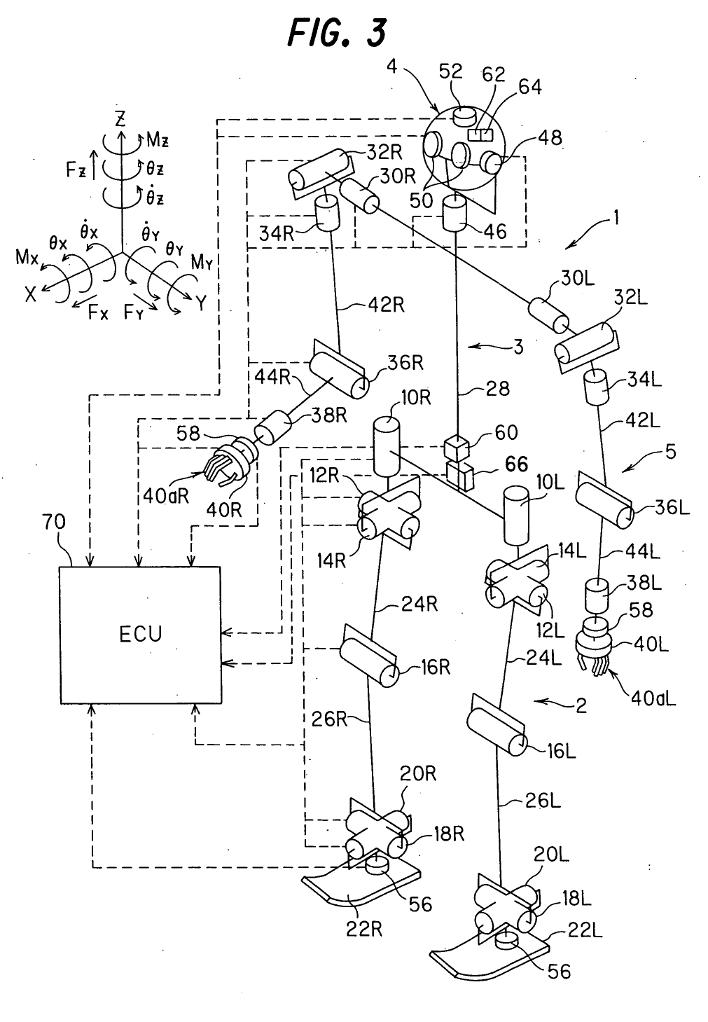

FIG. 3 is an explanatory diagram showing a skeletonized view of the robot 1. The internal structures of the robot 1 will be explained with reference to this drawing, with primary focus on the joints. As illustrated, the leg linkages 2 and arm linkages 5 on either the left or right of the robot 1 are equipped with six joints driven by 11 electric motors.

Specifically, the robot 1 is equipped at its hips (crotch) with electric motors 10R, 10L (R and L indicating the right and left sides; hereinafter the indications R and L will be omitted as is apparent for its symmetric structure) constituting joints for swinging or swiveling the leg linkages 2 around a vertical axis (the Z axis or vertical axis), electric motors 12 constituting joints for driving (swinging) the leg linkages 2 in the pitch (advance) direction (around the Y axis), and electric motors 14 constituting joints for driving the leg linkages 2 in the roll (lateral) direction (around the X axis), is equipped at its knees with electric motors 16 constituting knee joints for driving the lower portions of the leg linkages 2 in the pitch direction (around the Y axis), and is equipped at its ankles with electric motors 18 constituting foot (ankle) joints for driving the distal ends of the leg linkages 2 in the pitch direction (around the Y axis) and electric motors 20 constituting foot (ankle) joints for driving them in the roll direction (around the X axis).

As set out in the foregoing, the joints are indicated in FIG. 3 by the axes of rotation of the electric motors driving the joints (or the axes of rotation of transmitting elements (pulleys, etc.) connected to the electric motors for transmitting the power thereof). Feet 22 are attached to the distal ends of the leg linkages 2.

In this manner, the electric motors 10, 12 and 14 are disposed at the crotch or hip joints of the leg linkages 2 with their axes of rotation oriented orthogonally, and the electric motors 18 and 20 are disposed at the foot joints (ankle joints) with their axes of rotation oriented orthogonally. The crotch joints and knee joints are connected by thigh links 24 and the knee joints and foot joints are connected by shank links 26.

The leg linkages 2 are connected through the crotch joints to the body 3, which is represented in FIG. 3 simply by a body link 28. The arm linkages 5 are connected to the body 3, as set out above.

The arm linkages 5 are configured similarly to the leg linkages 2. Specifically, the robot 1 is equipped at its shoulders with electric motors 30 constituting joints for driving the arm linkages 5 in the pitch direction and electric motors 32 constituting joints for driving them in the roll direction, is equipped with electric motors 34 constituting joints for swiveling the free ends of the arm linkages 5, is equipped at its elbows with electric motors 36 constituting joints for swiveling parts distal thereof, and is equipped at the distal ends of the arm linkages 5 with electric motors 38 constituting wrist joints for swiveling the distal ends. Hands (end effectors) 40 are attached to the distal ends of the wrists.

In other words, the electric motors 30, 32 and 34 are disposed at the shoulder joints of the arm linkages 5 with their axes of rotation oriented orthogonally. The shoulder joints and elbow joints are connected by upper arm links 42 and the elbow joints and wrist joints are connected by forearm links 44.

Although not shown in the figure, the hands 40 are equipped with a driving mechanism comprising five fingers 40a. The fingers 40a are configured to be able to carry out a task, such as grasping an object.

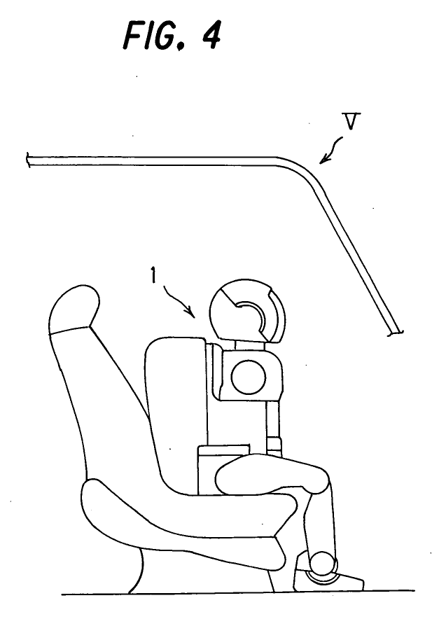

The head 4 is connected to the body 3 through an electric motor (comprising a neck joint) 46 around a vertical axis and a head nod mechanism 48 for rotating the head 4 around an axis perpendicular thereto. As shown in FIG. 3, the interior of the head 4 has mounted therein two CCD cameras (external sensor; vision sensor) 50 that can produce stereoscopic images, and a voice input/output device 52. The voice input/output device 52 comprises a microphone (external sensor; hearing sensor) 52a and a speaker 52b, as shown in FIG. 4 later.

Owing to the foregoing configuration, the leg linkages 2 are each provided with 6 joints constituted of a total of 12 degrees of freedom for the left and right legs, so that during locomotion the legs as a whole can be imparted with desired movements by driving (displacing) the six joints to appropriate angles to enable desired walking in three-dimensional space. Further, the arm linkages 5 are each provided with 5 joints constituted of a total of 10 degrees of freedom for the left and right arms, so that desired tasks can be carried out by driving (displacing) these 5 joints to appropriate angles. In addition, the head 4 is provided with a joint and the head nod mechanism constituted of two 2 degrees of freedom, so that the head 4 can be faced in a desired direction by driving these to appropriate angles.

FIG. 4 is a side view showing the robot 1 seated in the front passenger's seat of a vehicle (mobile unit) V. The robot 1 is configured for seating in the vehicle V or other mobile unit by driving the aforesaid joints. In this embodiment, the robot 1 sits in the front passenger's seat to guard the vehicle V when the driver leaves the vehicle V after parking it such as at night.

Each of the electric motors 10 and other motors is provided with a rotary encoder that generates a signal corresponding to at least one among the angle, angular velocity and angular acceleration of the associated joint produced by the rotation of the rotary shaft of the electric motor.

A conventional six-axis force sensor (internal sensor; hereinafter called “force sensor”) 56 attached to each foot member 22 generates signals representing, of the external forces acting on the robot, the floor reaction force components Fx, Fy and Fz of three directions and the moment components Mx, My and Mz of three directions acting on the robot from the surface of contact.

A similar force sensor (six-axis force sensor) 58 attached between each wrist joint and hand 40 generates signals representing external forces other than floor reaction forces acting on the robot 1, namely, the three external force (reaction force) components Fx, Fy and Fz and the three moment components Mx, My and Mz acting on the hand 40 from a touched object.

An inclination sensor (internal sensor) 60 installed on the body 3 generates a signal representing at least one of inclination (tilt angle) of the body 3 relative to vertical and the angular velocity thereof, i.e., representing at least one quantity of state such as the inclination (posture) of the body 3 of the robot 1.

A GPS receiver 62 for receiving signals from the Global Positioning System (GPS) and gyro (gyrocompass) 64 are installed inside the head 4 in addition to the aforesaid CCD cameras 50 and voice input-output unit 52. An acceleration sensor (internal sensor) 66 installed near the center of gravity of robot 1 (in the vicinity of the inclination sensor 60) generates a signal proportion to the acceleration acting on the robot 1.

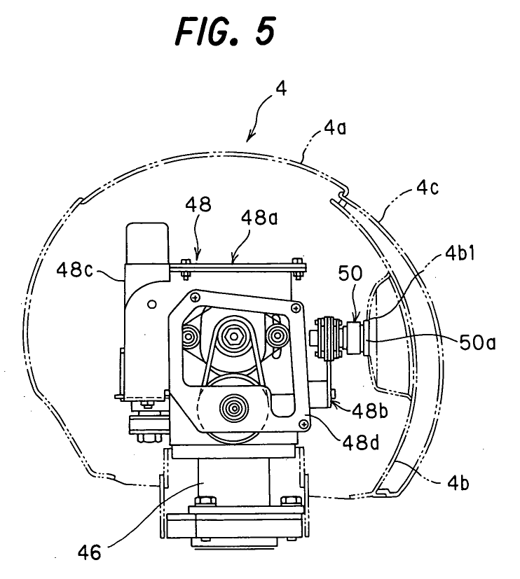

The attachment of the CCD cameras 50 and the nod mechanism 48 of the head 4 will now be explained with reference to FIG. 5. The nod mechanism 48 comprises a first mount 48a rotatable about a vertical axis and a second mount 48b rotatable about a roll axis.

The nod mechanism 48 is constituted by coupling the second mount 48b with the first mount 48a, in a state with the first mount 48a coupled with the electric motor (joint) 46, and the CCD cameras 50 are attached to the second mount 48b. Further, a helmet 4a that is a constituent of the head 4 covering the first and second mounts 48a, 48b, including a rotary actuator 48c (and another not shown), is joined in the direction perpendicular to the drawing sheet to a stay 48d substantially unitary with the second mount 48b, thereby completing the head 4. The voice input-output unit 52 is also installed in the head 4 but is not shown in FIG. 5.

A visor (protective cover) 4b is attached to the front end of the helmet 4a of the head 4 and a curved shield 4c made of transparent acrylic resin material is similarly attached to the helmet 4a outward of the visor 4b. The CCD cameras 50 are accommodated inward of the visor 4b. The visor 4b is formed at regions opposite openings formed for passage of light to the CCD cameras 50, i.e., at a position where lens windows 50a of the CCD cameras 50 look outward, with two holes 4b1 of approximately the same shape as the lens windows 50a. Although not shown in the drawing, the two holes 4b1 for the CCD cameras are formed at locations corresponding to eye sockets of a human being. Thus, the CCD cameras 50 are accommodated inward of the visor 4b that is formed with holes 4b1 at positions corresponding to lens windows 50a of the CCD cameras.

The structure explained in the foregoing makes the helmet 4a of the head 4 substantially unitary with the second mount 48b, so that the direction from which the CCD cameras 50 fastened to the second mount 48b receive light always follows the movement of the helmet 4a. Moreover, since the shield 4c is attached to the helmet 4a, light passing in through the shield 4c always passes through the same region regardless of the direction in which the CCD cameras 50 are pointed. As a result, the refractive index of the light passing through the shield 4c never changes even if the curvature of the shield 4c is not absolutely uniform. The images taken by the CCD cameras 50 are therefore free of distortion so that clear images can be obtained at all times.

The explanation of FIG. 3 will be continued. The outputs of the force sensors 56 and the like are sent to an electronic control unit (ECU) 70 comprising a microcomputer. The ECU 70 is accommodated in the housing unit 6. For convenience of illustration, only the inputs and outputs on the right side of the robot 1 are indicated in the drawing.

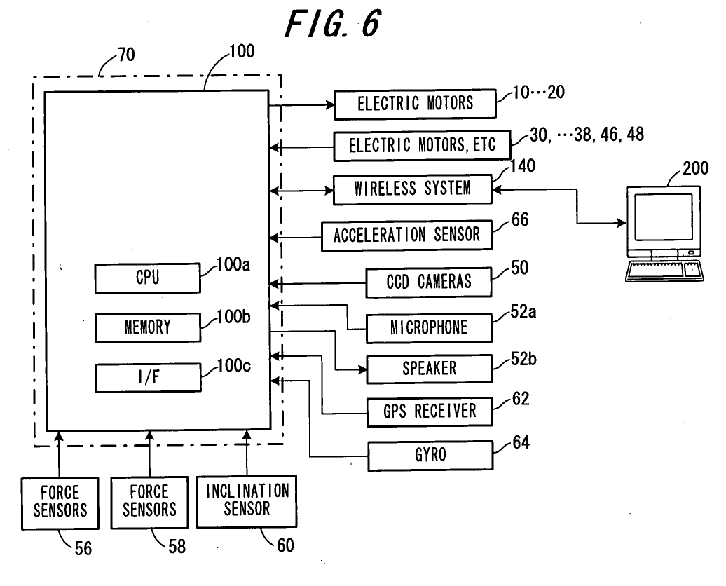

FIG. 6 is a block diagram showing the configuration of the ECU 70.

As illustrated, the ECU 70 is equipped with a microcomputer 100 comprising a CPU 100a, memory unit 100b and input-output interface 100c. The ECU 70 calculates joint angular displacement commands that it uses to control the electric motors 10 and other motors constituting the joints so as to enable the robot 1 to keep a stable posture while moving. As explained below, it also performs various processing operations required for performing security tasks. These will be explained later.

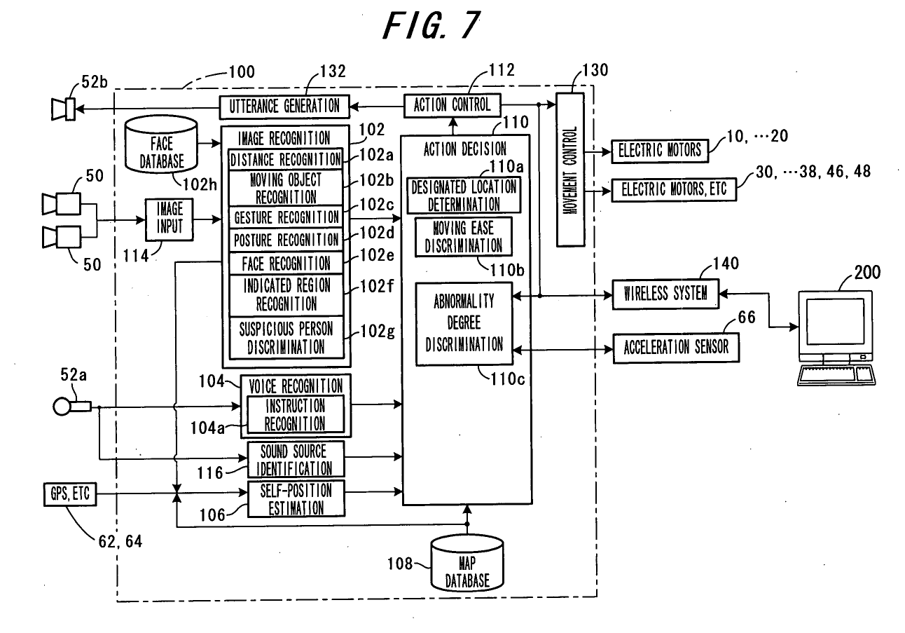

FIG. 7 is block diagram showing the processing operations of the CPU 100a in the microcomputer 100 of the ECU 70. It should be noted that many of the sensors are not shown in FIG. 7.

As can be seen from FIG. 7, the CPU 100a is equipped with, inter alia, an image recognition unit 102, voice recognition unit 104, self-position estimation unit 106, map database 108, action decision unit 110 for deciding actions of the robot 1 based on the outputs of the foregoing units, and action control unit 112 for controlling actions of the robot 1 based on the actions decided by the action decision unit 110. For convenience of illustration, the term “unit” is omitted in the drawing.

These units will be explained individually.

The image recognition unit 102 comprises a distance recognition unit 102a, moving object recognition unit 102b, gesture recognition unit 102c, posture recognition unit 102d, face region recognition unit 102e, indicated region recognition unit 102f, suspicious person discriminator 102g, and face database 102h. Stereoscopic images of the surroundings taken and produced by the two CCD cameras 50 are inputted to the distance recognition unit 102a through an image input unit 114.

The distance recognition unit 102a calculates data representing distances to imaged objects from the parallax of the received images and creates distance images. The moving body recognition unit 102b receives the distance images and calculates differences between images of multiple frames to recognize (detect) moving objects such as people, vehicles and the like.

The gesture recognition unit 102c utilizes techniques taught in Japanese Laid-Open Patent Application No. 2003-077673 (proposed by the assignee) to recognize human hand movements and compares them with characteristic hand movements stored in memory beforehand to recognize gestured instructions accompanying human utterances.

The posture recognition unit 102d uses techniques taught in Japanese Laid-Open Patent Application No. 2003-039365 (proposed by the assignee) to recognize human posture. The face region recognition unit 102e uses techniques taught in Japanese Laid-Open Patent Application No. 2002-216129 (proposed by the assignee) to recognize human face regions. The indicated region recognition unit 102f uses techniques taught in Japanese Laid-Open Patent Application No. 2003-094288 (proposed by the assignee) to recognize regions or directions indicated by human hands and the like.

The suspicious person discriminator 102g compares each recognized face region with faces registered in the face database 102h and when there is no match discriminates or decides that the imaged person is a suspicious person. The faces registered in the face database 102h beforehand are those of the owner of the vehicle V, the owner's family members and other persons with respect to whom the warning and other preventive actions explained later need not be taken when the person approaches the vehicle V with the robot 1 seated in the front passenger's seat.

The voice recognition unit 104 is equipped with an instruction region recognition unit 104a. The instruction region recognition unit 104a receives the human voices inputted through the microphone 52a of the voice input-output unit and uses vocabulary stored in the memory unit 100b beforehand to recognize human instructions or instruction regions (regions instructed by a person). The voice inputted from the microphone 52a is sent to a sound source identification unit 116 that identifies or determines the position of the sound source and discriminates between voice and other abnormal sounds produced by, for instance, someone trying to force a door open.

The self-position estimation unit 106 receives GPS signals or the like through a GPS receiver 62 and uses them to estimate (detect) the current position of the robot 1 and the direction in which it is facing.

The map database 108 resides in the memory unit 100b and stores map information compiled in advance by recording the locations of obstacles within the surrounding vicinity.

The action decision unit 110 is equipped with a designated location determination unit 110a, moving ease discrimination unit 110b, and abnormality degree discrimination unit 110c.

Based on the region the image recognition unit 102 recognized as that designated by a person and the designated region zoomed in by the voice recognition unit 104, the designated location determination unit 110a determines or decides, as a desired movement destination value, the location designated by the person.

The moving ease discrimination unit 110b recognizes the locations of obstacles present in the map information read from the map database 108 for the region around the current location of the robot 1, defines the areas near the obstacles as hazardous zones, defines zones up to a certain distance away from the defined hazardous zones as potentially hazardous zones and judges the moving ease in these zones as “difficult,” “requiring caution” or similar.

The action decision unit 110 uses the recognition results of the image recognition unit 102 and voice recognition unit 104 to discriminate whether it is necessary to move to the designated location determined by the designated location determination unit 110a. Further, when the moving ease discrimination unit 110b makes a “difficult” determination, for example, based on the determined moving ease, the action decision unit 110 decides to lower the walking speed or the like and decides the next action of the robot 1 in response to information received from the image recognition unit 102, voice recognition unit 104 and the like. For example, when sound source position information is outputted by the sound source identification unit 116, the action decision unit 110 decides to reorient the robot 1 to face toward the sound source.

Explanation will be made later regarding the abnormality degree discrimination unit 110c.

The action decisions of the action decision unit 110 are sent to the action control unit 112. The action control unit 112 responds to the action decisions by outputting action instructions to a movement control unit 130 or an utterance generation unit 132.

The movement control unit 130 is responsive to instructions from the action control unit 112 for outputting drive signals to the electric motors 10 and other motors of the legs 2, head 4 and arms 5, thereby causing the robot 1 to move (act).

In accordance with instructions from the action control unit 112, the utterance generation unit 132 uses character string data for utterances to be made stored in the memory unit 100b to synthesize voice signals for the utterances and uses them to drive a speaker 52b of the voice input-output unit 52. The character string data for utterances to be made include data for security related warnings such as “Stop or I will call the police!” Moreover, the utterance generation unit 132 can generate synthesized signals and drive the speaker 52b to produce not only human voice warnings but also loud warning noises.

The abnormality degree discrimination unit 110c will now be explained.

As explained earlier, this invention is directed to provide a security robot capable of boarding a mobile unit that can itself discriminate the degree of abnormal situations and act accordingly in response.

In line with this object, the security robot in accordance with this embodiment comprises the abnormality degree discrimination unit 110c, which is inputted with information acquired from the outputs of a group of sensors including the acceleration sensor (internal sensor) 66 for detecting conditions inside the robot 1, the CCD cameras (external sensors) 50 and the microphone (external sensor) 52a for detecting conditions outside the robot 1, i.e., with information regarding acceleration acting on the robot 1, image information obtained from the image recognition unit 102 and voice information obtained from the voice recognition unit 104, which uses this inputted information to discriminate the degree of abnormality the vehicle V is experiencing, and which also operates the action control unit 112 as a preventive action means for taking preventive action in response to the discriminated degree of abnormality.

The ECU 70 is further equipped with a wireless system 140. The wireless system 140 can operate through a wireless communications terminal (not shown) to communicate with the exterior, e.g., with a personal computer (or cellular telephone) 200 of the owner of the vehicle V, so that at least the image information and voice recognition information acquired from the outputs of the external sensors 50, 52, can be sent to the exterior of the vehicle (mobile unit) V. The party communicated with need not necessarily be the owner of the vehicle V but can instead be the dealer from which the vehicle V was purchased or a security services company.

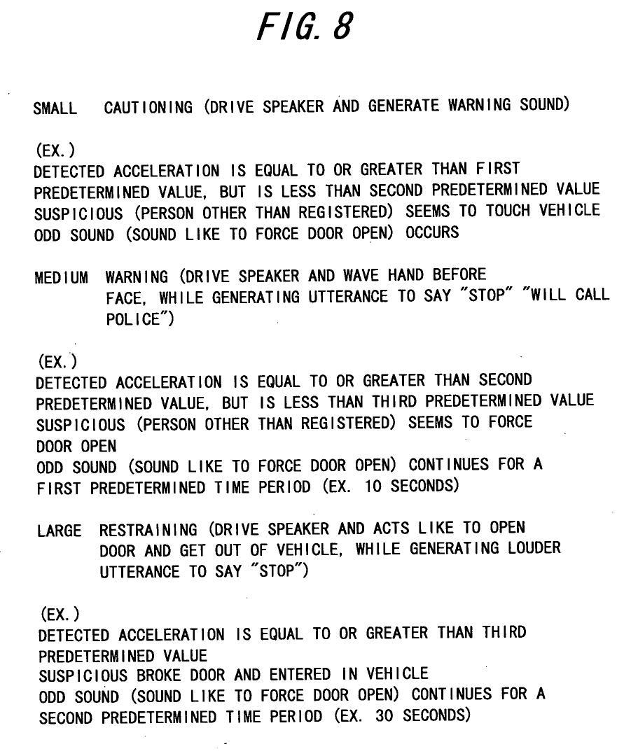

FIG. 8 sets out degrees of abnormality discriminated by the abnormality degree discrimination unit 110c and preventive actions taken by the movement control unit 130 and the like in response. As shown, degree of abnormality is classified into three categories designated SMALL, MEDIUM and LARGE which are respectively associated with three kinds of preventive action: Cautioning, Warning and Restraining.

The first, second and third predetermined values of detected acceleration mentioned in FIG. 8 can be set at, for example, 0.05 G, 0.1 G and 0.2 G (G: gravitational acceleration). The reason for installing the acceleration sensor 66 and using it to detect the acceleration acting on the robot 1 is that when an unauthorized person enters the vehicle V by forcing a door open, for example, and then sits in the driver's seat, starts the engine and drives the vehicle V, acceleration acts on the robot 1 in the directions of the X and Y axes (shown in FIG. 3), i.e., the robot 1 experiences shaking, so that driving (movement) of the vehicle V can be inferred from the detected values.

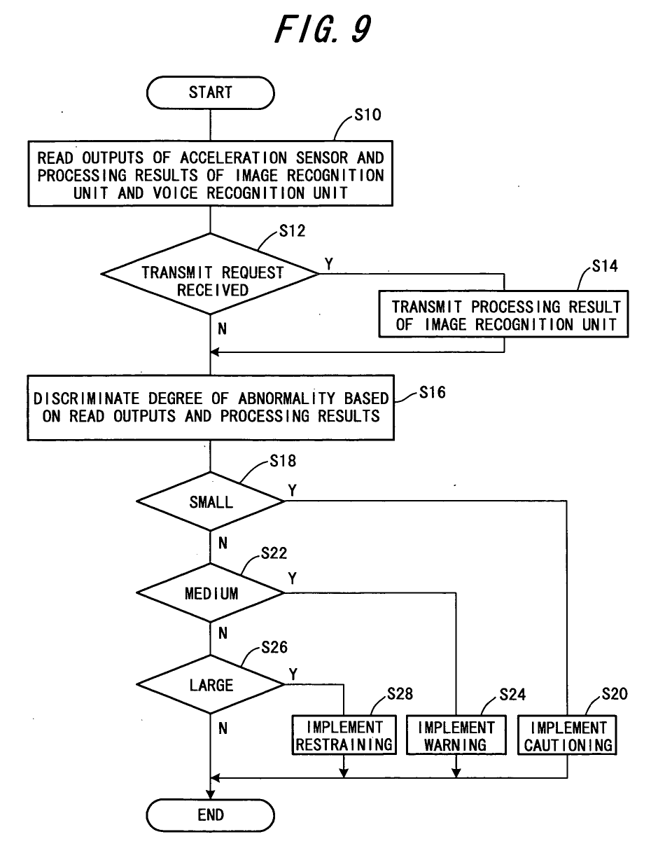

The operation of the robot 1 shown in FIG. 1 will now be explained with reference to the flowchart of FIG. 9. Exactly speaking, these are operations executed by the CPU 100a of the microcomputer 100 of the ECU 70.

The routine shown in FIG. 9 assumes that the vehicle V is parked and stationary, the driver is not present, and the robot 1 is seated in the front passenger's seat as a security robot.

In S10, the output of the acceleration sensor 66, and the processing results, i.e., outputs, of the image recognition unit 102 and voice recognition unit 104 are read. Next in S12, it is checked whether a transmit request has been received from the personal computer 200 of, for example, the owner of the vehicle V through the computer's wireless communications terminal and the wireless system 140 on the side of the ECU 70.

When the result is Yes, the program goes to S14, in which, of the acquired outputs, the processing result (output) of the image recognition unit 102 is transmitted to the personal computer 200 through the wireless system 140. This enables the owner to monitor the vehicle V from a remote location. When the result in S12 is No, S14 is skipped.

Next, in S16, the degree of abnormality is discriminated as explained earlier based on the read outputs (information), whereafter the program goes to S18, in which it is checked whether the discriminated degree is SMALL. When the result in S18 is Yes, the program goes to S20, in which the Cautioning shown as a preventive action in FIG. 8 is implemented or executed. This action is carried out by, in the CPU 100a, operating the action control unit 112 to cause the utterance generation unit 132 to generate a synthesized warning signal in accordance with the discrimination result of the abnormality degree discrimination unit 110c, and driving the speaker 52b of the voice input-output unit 52 to produce a warning sound.

When the result in S18 is No, the program goes to S22, in which it is checked whether the discriminated degree is MEDIUM, and when the result is Yes, the program goes to S24, in which the Warning shown as a preventive action in FIG. 8 is implemented or executed. This action is carried out by, in the CPU 100a, operating the action control unit 112 to cause the utterance generation unit 132 to generate a synthesized voice signal in accordance with the discrimination result of the abnormality degree discrimination unit 110c, driving the speaker 52b of the voice input-output unit 52 to produce an utterance, and in the movement control unit 130 conducting controlled driving of the electric motors 30 and the like of the arms 5.

When the result in S22 is No, the program goes to S26, in which it is checked whether the discriminated degree is LARGE, and when the result is Yes, the program goes to S28, in which the Restraining shown as a preventive action in FIG. 8 is implemented or executed. This action is carried out by, in the CPU 100a, operating the action control unit 112 to cause the utterance generation unit 132 to generate a synthesized voice signal in accordance with the discrimination result of the abnormality degree discrimination unit 110c, driving the speaker 52b of the voice input-output unit 52 to produce an utterance, and in the movement control unit 130 conducting controlled driving of the electric motors 10 and various other electric motors of the legs 2, such that the person is restrained from doing.

A record of the processing performed in S16 to S28, particularly the processing performed in S28, can be stored in the memory unit 100b of the microcomputer 100 of the ECU 70, thereby making it possible to review the history of theft attempts and other abnormal situations that arise.

The embodiment is thus configured to have a security robot (1) that boards a mobile unit (vehicle) V to protect the mobile unit from theft, comprising: an internal sensor (acceleration sensor 66) installed at the robot and generating an output indicative of condition inside the robot; an external sensor (CCD cameras 50, microphone 52a) installed at the robot and generating an output indicative of condition outside the robot; an abnormality degree discriminator (CPU 100a, abnormality degree discrimination unit 110c, S10 to S16) discriminating a degree of abnormality (i.e., SMALL, MEDIUM, LARGE) that the mobile unit is experiencing based on information obtained from the outputs of the internal sensor and the external sensor; and an action controller (CPU 100a, action control unit 112, S18 to S28) taking preventive action in response to the discriminated degree of abnormality.

The security robot further includes: a transmitter (wireless unit 140) transmitting the information obtained at least from the external sensor to exterior of the robot, i.e., a personal computer (or cellular telephone) 200 of the owner of the mobile unit (vehicle) V.

In the security robot, the internal sensor comprises an acceleration sensor (66) that generates an output proportion to the acceleration acting on the robot.

In the security robot, the external sensor comprises a vision sensor (CCD cameras 50) that generates an output indicative of images outside the robot.

In the security robot, wherein the vision sensor comprises a CCD camera (50) accommodated inward of a visor (4b) that is formed with a hole (4b1) at a position corresponding to a lens window (50a) of the CCD camera. The hole (4b1) has a same diameter as the lens window (50a).

In the securing robot, the external sensor comprises a hearing sensor (microphone 52a) that generates an output indicative of sound generated outside the robot, and the hearing sensor comprises a microphone (52a).

The securing robot comprises a biped robot having a body (3) and a pair of legs (2) connected to the body.

It should be noted in the above that, although the vehicle V has been taken as an example of a mobile unit in the foregoing, this invention is not limited to application to a vehicle but can be similarly applied to a boat, airplane or other mobile unit.

It should also be noted that, although a biped robot has been taken as an example of the invention robot in the foregoing, the robot is not limited to a biped robot and can instead be a robot with three or more legs and is not limited to a legged mobile robot but can instead be a wheeled or crawler-type robot.

Japanese Patent Application No. 2004-193756 filed on Jun. 30, 2004, is incorporated herein in its entirety.

While the invention has thus been shown and described with reference to specific embodiments, it should be noted that the invention is in no way limited to the details of the described arrangements; changes and modifications may be made without departing from the scope of the appended claims.

What is claimed is:

1. A security robot that boards a mobile unit to protect the mobile unit from theft, comprising:
an internal sensor installed at the robot and generating an output indicative of condition inside the robot;
an external sensor installed at the robot and generating an output indicative of condition outside the robot;
an abnormality degree discriminator discriminating a degree of abnormality that the mobile unit is experiencing based on information obtained from the outputs of the internal sensor and the external sensor; and
an action controller taking preventive action in response to the discriminated degree of abnormality.

2. The security robot according to claim 1, further including:
a transmitter transmitting the information obtained at least from the external sensor to exterior of the robot.

3. The security robot according to claim 1, wherein the internal sensor comprises an acceleration sensor that generates an output proportion to the acceleration acting on the robot.

4. The security robot according to claim 1, wherein the external sensor comprises a vision sensor that generates an output indicative of images outside the robot.

5. The security robot according to claim 4, wherein the vision sensor comprises a CCD camera accommodated inward of a visor that is formed with a hole at a position corresponding to a lens window of the CCD camera.

6. The security robot according to claim 5, wherein the hole has a same diameter as the lens window.

7. The securing robot according to claim 1, wherein the external sensor comprises a hearing sensor that generates an output indicative of sound generated outside the robot.

8. The securing robot according to claim 7, wherein the hearing sensor comprises a microphone.

9. The securing robot according to claim 1, wherein the robot comprises a biped robot having a body and a pair of legs connected to the body.
